(19) United States
(12) Patent Application Publication
(10) Pub. No.: US 2008/0243568 A1
(43) Pub. Date: Oct. 2, 2008

(54) INFORMATION RETRIEVAL SYSTEM

(76) Inventor: TENEYKE M. SMITH, Boston, MA (US)

Correspondence Address: CESARI AND MCKENNA, LLP, 88 BLACK FALCON AVENUE, BOSTON, MA, 02210, US

(21) Appl. No.: 11/866,790

(22) Filed: Oct. 3, 2007

Related U.S. Application Data
(60) Provisional application No. 60/827,955, filed on Oct. 3, 2006.

(51) Int. Cl. G06Q 10/00

(52) U.S. Cl. 705/7

(57) ABSTRACT

The present invention describes mining UCC filings from the various states. The data from the UCC filings is arranged into searchable databases from which competitive marketing and financial information may be gleaned and used to advantage. Details of dates, costs, buyers, sellers, financial terms and financial backers, banks, and others may be gleaned and used for competitive purposes. Special leases and purchasing terms may be formulated at advantageous times that specifically target an area with specificity that enhances the prospects for success.

### CROSS-REFERENCE TO RELATED APPLICATIONS

The present application claims the benefit of U.S. Provisional Patent Application Ser. No. 60/827,955, which was filed on Oct. 3, 2007, by Teneyke Smith for an INFORMATION RETRIEVAL SYSTEM and is hereby incorporated herein by reference.

### BACKGROUND OF THE INVENTION

1. Field of the Invention

The present application relates to financing of equipment to businesses, and more particularly to finding various vendors of equipment and arranging finance for their customers.

2. Background Information

In the regular course of business leasing, companies and banks file UCC forms in the various U.S. states to secure their interests in the particular piece of equipment being financed. Although these UCC (Uniform Commercial Code) filings are public information containing customer's purchases of specific equipment and financing details, the filings are used by banks searching for liens and determining if additional collateral is needed for proposed financing.

For example, if a customer pledges some equipment he owns as collateral, the bank often may do a “lien search” which would entail checking UCC's on this customer to make sure no other entity has a first lien (higher priority) on that equipment.

UCC filings have been available for many (fifty?) years, but the information and data contained therein has been ignored beyond that discussed just above.

### SUMMARY OF THE INVENTION

The present invention provides for “mining” information from these UCC filings for, among other aspects, new business or expanded business opportunities and for competitive information. Typically this mined data is organized into databases that are arranged for easy searching.

An embodiment of the present invention advantageously mines this information in order to suggest a financial plan that is specific and tailored to a particular equipment distributor or manufacturer and their specific customers or their prospective customers. This specific data is provided in the corresponding UCC filings, and such specificity enhances the chances of successfully selling of the plan to the distributor or manufacturer.

This information on customers, types of equipment and financial details is valuable for competitive businesses. Searches on the databases may be run on particular customers, manufactures, financing terms, types and ages of equipment, and banks to yield competitive information and data. This information, for example, would allow equipment dealers and manufacturers to know of competitors, and what and how (lease outright sale) these competitors are selling, to their customers.

Illustrative embodiments of the present invention provide the following:

Information on manufactures may be “mined” to uncover new leads on what is being sold (and financed) to whom.

UCC information may uncover prospective business where a UCC filing is made but delivery and financing may not be yet determined. Again a new source of business leads.

An embodiment of the invention may provide a database covering competition; who is financing what machines to whom machines (and how many). Such information may provide a company a competitive edge over rivals.

An embodiment of the present invention may help equipment manufacturer's and dealers sell more machines and secure financing and equipment for many companies in the United States. This is clearly a useful and concrete result, and the inventive approach has been heretofore overlooked.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1 is a flow chart representing an embodiment of the invention;

FIG. 2 is a representative block diagram of a computing system that may be used in an embodiment of the invention;

FIG. 3A is a copy of a typical UCC form; and

FIG. 3B illustrates the information that may be on the form of FIG. 3A.

### DETAILED DESCRIPTION OF AN ILLUSTRATIVE EMBODIMENT

In one illustrative embodiment, the present invention provides for locating manufacturers and equipment dealers in order to offer them financial services that they may in turn offer to their customers. These transactions are typically submitted to banks that may provide the financing. If approved and when the equipment is delivered and paid for, the entity that brought the parties together may be paid a fee.

In one embodiment, the present invention provides for mining the UCC filings to create data bases that may advantageously help equipment manufactures and distributors in the following ways:

### 1. Identifying and Quantifying the Business of New and Existing Customers and Market Share:

A manufacturer/distributor will know to whom the competition is selling machines and the cost and type of machines being sold.

Advantageously, the present invention removes “the guess work” from analyses of competition and gives accurate up-to-date information for their analyses. Manufactures and distributors have relevant data for their strategic sales, service and delivery planning.

### 2. Targeted Sales:

For example, a manufacturer's sales force and dealer network was limiting their calling to their known customers. This is common as salesmen tend to only call on a particular group of customers with whom they feel comfortable. A search of an inventive data base, derived from UCC filings, and followed up personally may discover customers with older (ten or more years) machines that are candidate for new equipment. The new machines may run much faster, require lower set up times and effort, and have lower costs and better reliability. Such information, from UCC data bases, allowed the manufacturer to target these specific customers with specificity that significantly demonstrates a competitive advantage.

### 3. Uncovering Competitive Strategies and Customers of Competitors:

In one example, in a consumable business, a company might can give away razors in order to grow the continuing business of supplying a never ending supply of razor blades. This may be their most profitable and consistent income. Having access to an inventive database illustrating competitive vendors will allow a business a strategic competitive advantageous.

### 4. Uncovering Competitor's Customers and Installed Products:

For example, service revenue is an important part of many businesses. In one instance, a company's service department might have the ability to service other manufacturer's equipment. Using one example of the present inventive data base, the installed competitor's machines may be identified and located so that a company could market equipment, spare parts and service contracts to the owners of the installed competitor's equipment.

### 5. Uncover Business Trends:

For example, an inventive derived data base might uncovered companies buying sign machines. Many of these found companies might not be not associated with the graphic arts community—the typical sign machine customer. Manufacture's of graphic arts equipment may find, to their benefit, that their market included super markets, drug stores, colleges and universities, municipalities, non profits, and other businesses not usually identified with the graphic arts market.

### 6. Size of the Market:

The present invention in an illustrative embodiment can provide derived information that allows manufacturers to measure accurately the size of their markets. For example, a printing press manufacturer may be apprised of how many printing presses were sold in the United States within a year. With this hard information, they would be able to allocate the proper support to the U.S. market rather then other less productive areas of the world.

### 7. Complimentary Sales:

When a certain type of machine is sold, there often is a market for another complimentary type of equipment. For example, a customer buying a printing machine usually will also need a paper folding machine. Supplying the folding machine manufacturer hard information on sales of printing machines, using an illustrative embodiment of the present invention, provides a folding machine manufacturer with newly founded sales leads.

### 8. Lease/Loan Expirations:

An illustrative embodiment of the present invention allows lease/loan specifics to be gleaned. For example, an illustrative example of the present invention allows equipment manufactures, dealers and their sales people to know when a lease is about to expire so they can go to the customer, in a timely fashion, to sell their equipment to that customer.

Calls to banks and their customers may provide additional financial details that can be combined in an embodiment of the present invention to provide an even greater competitive advantage. One embodiment may use docket type or software generated alerts and/or flags that will generate sales leads in a timely fashion.

### 9. Second Chance Opportunities:

In many instance, some states report their UCC information immediately. Such information may allow another equipment manufacturer or dealer to make a sale canceling the initial sale before it is completed. Since many manufacturers deliver large machines six or more months after the sale is agreed to, a nimble competitor, armed with information from an illustrative embodiment of the present invention, may be able to steal the sale.

The above embodiments or the present invention help a manufacturer or distributor find new customers. The following is directed to the financial aspects of the data gleaned from UCC filings.

The UCC form described below illustrates specifics of financial details that allows a competitive advantage for an entity to help a customer find an optimum finance program.

For Example:

### 1. Automatic Replacement Plan:

In a situation where a lease or loan was found to about expire. A manufacturer armed with this information may create an “Automatic Replacement Plan.” This inventive finance program, in connection with other illustrative embodiments of these present invention, may be tailored by the salesman of new equipment to pay off the balance of an existing loans or lease while selling and financing a new piece of equipment to the customer.

### 2. Rental Program:

Municipalities, colleges and state agencies are identified on UCC filings when they are purchasing equipment. Illustrative embodiments of the present invention may compile a searchable (although all will typically be searchable) database of these purchasers. An embodiment of the present invention includes a rental program for equipment being sold to municipalities, colleges and state agencies. When manufactures and equipment dealers are selling to these entities there is a large tedious, time consuming amount of work getting a quote and proposal ready. Then, typically, the purchase must be approved and put out to bid in an extremely time consuming process. Using an illustrative embodiment of the present invention, the equipment rental program may be offered to the purchasing entity that may not have to get approval on many occasions and may not have to be put out to bid. This saves having to deal with the red tape while pushing the sales cycle forward.

### 3. Target Marketing Plan:

As mentioned above, uncovering older installed machines by selective searching of an illustrative database, e.g., machines ten years or older, allows an entity to target machines that are ready for replacement. Such a customer may be targeted a (“Target Marketing Plan”) using an illustrative embodiment of the present invention.

### 4. Municipal Lease Program:

For those government customers identified by an illustrative embodiment of the present invention a “Municipal Lease Program” may be provided. With a “Municipal Lease Program,” the government entity may acquire lease financing with a one page application. In addition, the municipal lease documents may have “Non appropriations Clause”. With this clause if the lease is not funded, the government entity can simply give the equipment back.

As mentioned above, embodiments of the present invention may provide:

1 Information on manufactures may be “mined” to uncover new leads on what is being sold (and financed) to whom.
2. UCC information may uncover prospective business where a UCC filing is made but delivery and financing may not be yet determined. Again a new source of business leads.
3. An embodiment of the invention may provide a database covering competition; who is financing what machines to whom machines (and how many). Such information may provide a company a competitive edge over rivals.
4. An embodiment of the present invention may help equipment manufacturer's and dealers sell more machines and secure financing and equipment for many companies in the United States. This is clearly a useful and concrete result, and the inventive approach has been overlooked.

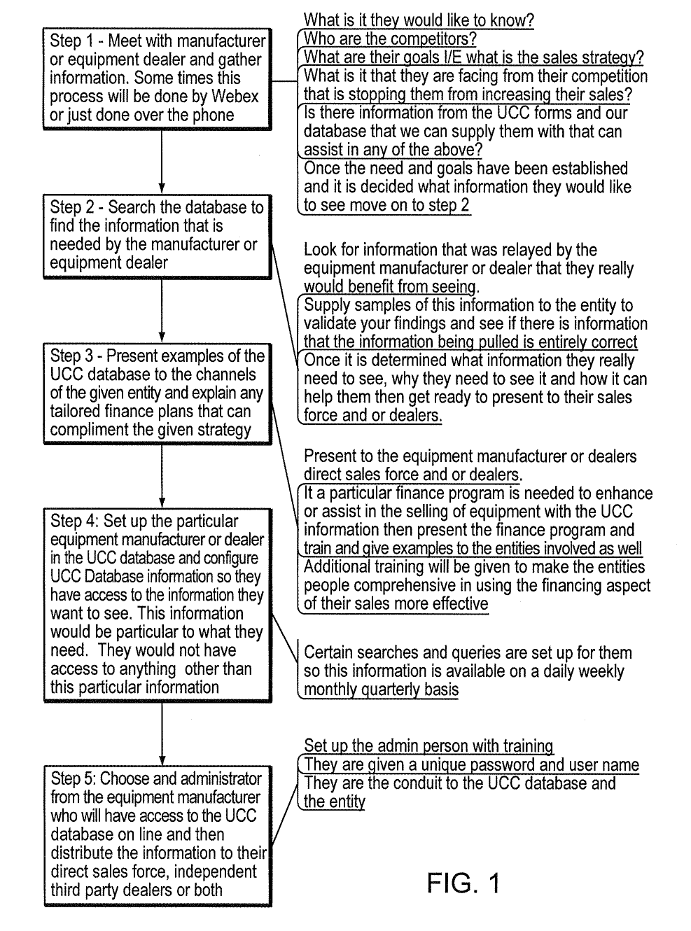

An embodiment of the invention is illustrated in FIG. 1 and described by the following process steps.

STEP 1—Meet with manufacturer or equipment dealer and gather information. Some times this process will be done over the phone.

The first step is a fact finding step where you identify the need of the manufacturer/dealer and or look for where the entity may find considerable use from having access to this data.

Example: One manufacturer “A” said his competition has told their customers that effective October 1 they will no longer be offering parts and service for machines they manufactured before 1980. These people will now not be able to get parts or service for machines. Manufacturer “A” would love to know where these machines are so he can offer parts that he stock, and still get in Europe. Manufacturer “A” can sell the parts and offer service for these machines to this financial advantage. Having an “Upgrade Plan” helps these customers buy “A's” modern equipment.

“A” takes their old machine in trade and sell them a new machines. A search of the UCC Database illustrated the ability to find these older machines all across America and use the information advantageously.

Example 2: It is clear that almost every time a large and small printing press is sold the buy will need a paper folding machine in the near future. This of course would be a great lead for this manufacturer's direct sales force and their entire independent third party dealers. An embodiment of the present invention mines the UCC database to supply this information. In most instances this information leads to buying a machine as well as financing for that machine.

STEP 2—Search the database to find the information that is needed by the manufacturer or equipment dealer.

In some instances the management of the particular equipment manufacturer of dealer may elect to have the information sent to them and they introduce it to their people. They then move forward quickly to set up a meeting with their direct sales force, independent third party dealers or both. Presentations to these entities benefit with the knowledge of knowing exactly what their needs are and what information they need and why.

STEP 3—Present examples of the UCC database to the channels of the given entity and explain any tailored finance plans that can compliment the given strategy.

Example: Consider Japanese digital press manufacturer that is up against a German press manufacturer who has sold digital presses in the United States for years. If the Japanese manufacturer knew to whom the German manufacturer had sold their digital presses it would allow the Japanese company to compete effectively since the Japanese press was a superior machine.

Example 2: One distributor of a particular press was selling a machine they were importing from Japan for $300,000 and then a large publicly traded US company started importing the same machine to the US and selling their machines for $250,000 which was their cost. The idea was they just wanted the consumable ink business that customers buying this type of machine would need. A rental program may be devised in which the customer would “rent” the equipment rather than actually purchase the machine. With this rental program a large part of the equipment cost is put at the end of the term which drastically lowers the payment because this large residual is not required until the end. Basically this drove the payment of our rental on a $300,000 machine substantially lower than conventional financing would have been on the $250,000 machine sold by their competition. Thus increasing the distributor's competitive advantage much in this market.

Offering Comprehensive training in an amortization software where the entities people will facilitate the sale and financing of equipment.

STEP 4 Step up the particular equipment manufacturer or dealer in a software embodiment of the present invention configured tailored to the manufacturer. This information would be particular to what their needs. They would not have access to anything other than this particular information.

At this point, a particular person chosen to be in the point person for the given entity would be trained in the use of there database using a secure password, etc. system. They would then distribute the information out to the proper people in their organization and channels.

In this part certain automatic processes will be set up to take place so the administrator chosen in the next step can get information automatically once they log in. For instance every time a lease or loan is about to expire on a piece of equipment that is either equipment the entity sold or one that their completion sold they will be notified automatically. Telemarketers will call the banks and leasing companies to find out these details for the entity.

STEP 5: Choose an administrator from the equipment manufacturer who will have access to an inventive embodiment of the UCC database online that is then distributed to their district sales force, independent third party dealers or both.

An embodiment of the invention may be used when a customer is purchasing equipment and/or needs assistance with financing.

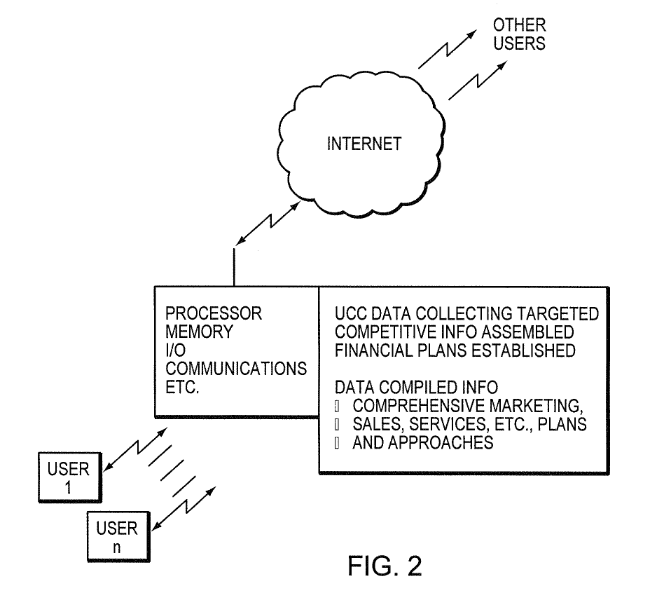

FIG. 2. is a computer system that may be used in an embodiment of the invention. The computer system 10 may be a single processor, multiple processors or multiple processors connected via a local area network or connected via the Internet. The user systems maybe smart or dumb terminals that communicate directly with the computer system. The various hardware/software entities may be strategically placed to facilitate the passage of an idea though the inventive system and process until it is locked up and discarded. In some case the idea may be reformulated as it progresses through the inventive system and emerge in a somewhat different form.

For example, a program may be resident on the computer system may interrogate all the states in the United States to extract the UCC forms and information. The programs may create searchable databases of related information over all the UCCs from the states. These data bases may assemble data that allows the advantageous competitive advantages described above. These data base may include, but are not limited to, financial details and specifics of who is buying, or leasing or renting from what supplier; and under what financial terms supplied by what bank of other such vendor; and what is being bought, leased or rented (model, type, etc.), etc.

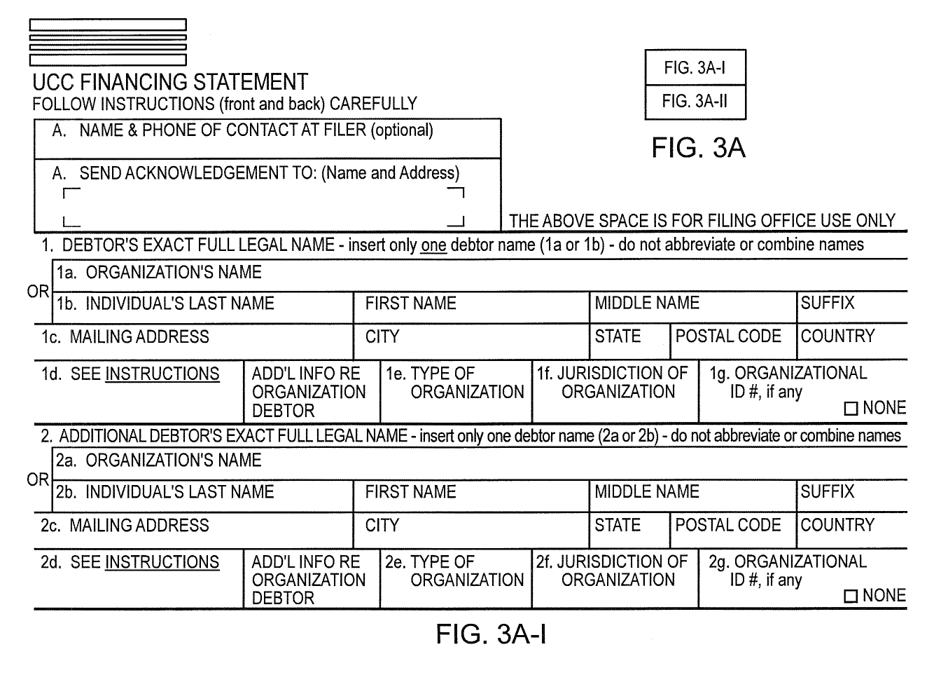

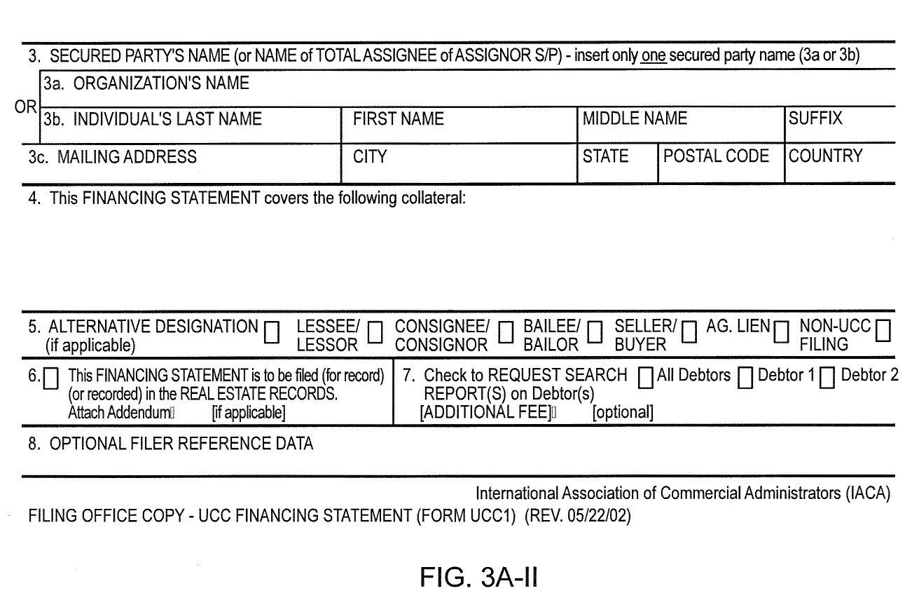

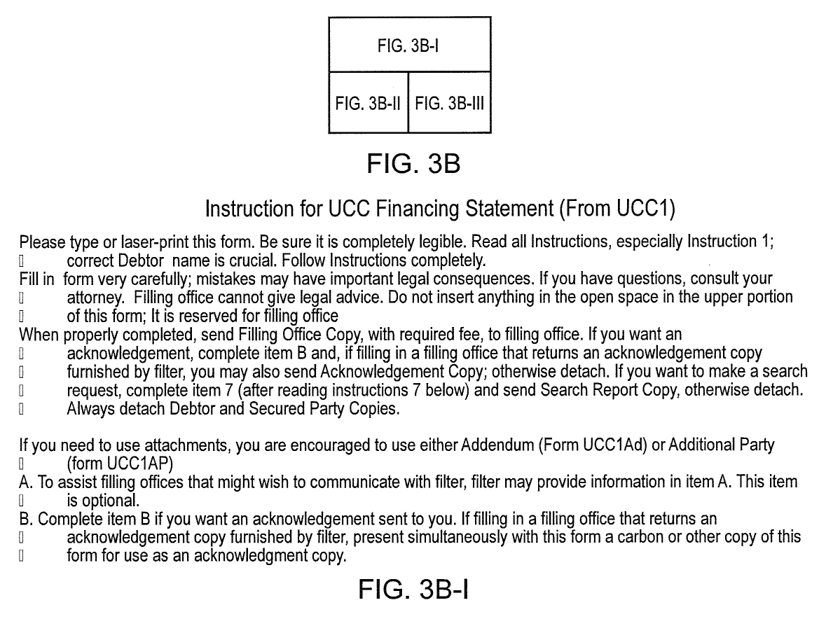

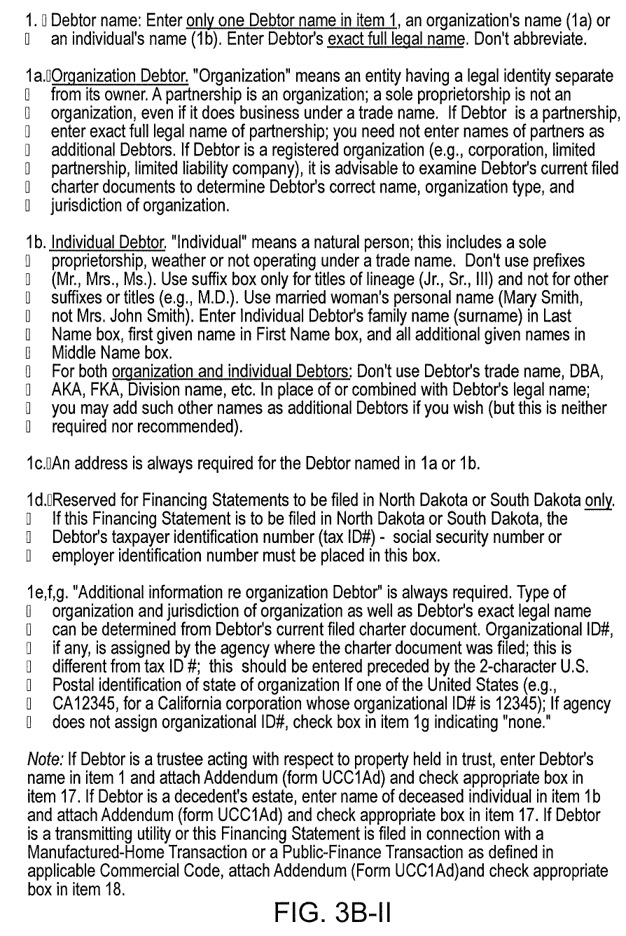

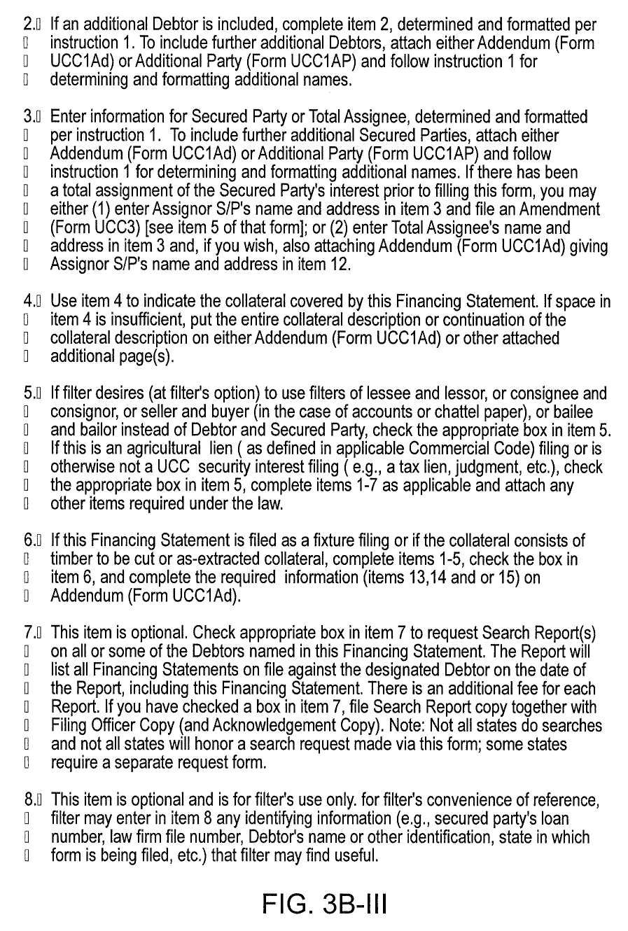

FIG. 3A is an illustrative UCC form that is routinely filed with the states in the United States. Note the areas to be filled out, and the instructions for filling out the form in FIG. 3B.

The debtor's name item 1e, the debtor's organization 1a or individual 1b and address 1c. Financial statements 1d and 1e.f. and g for additional required information. Any additional debtors 2, and 3 information for secured of assignee. Collateral 4, titles 5, financial statement 6, possible search reports 7 and possibly additional identifying information.

From specific UCC filings a manufacture that sold two large format printing machines is detailed where the lease expires in April of 2007 was found. Detailed information on prices and timing for the specific machines was found. This allows a competitor, well ahead of lease expiration, armed with the selling price, to target and be very competitive approaching the user.

In another example, a UCC filing detailed a paper cutting machine that lost a sale to a competitor. This is one data point illustrating market share.

In yet another UCC filing a paper folding machine salesman was aware that a large printing press was sold. This salesman has a very good sales lead.

In still another example, a customer in April of 2006 bought two Hewlett-Packard wide format printers. A competitor who lost this sale may still be able to market the consumables, e.g., inks. The competitor will also gain information for future sales.

In short a wealth of detailed information may be available on these UCC forms.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. A process for retrieving information comprising the steps of:
obtaining UCC filings,
extracting information from the filings;
forming databases of the information;
searching the databases for information related to competitive business advantages;
implementing a business strategy to take advantage of the competitive business opportunity.

2. The process of claim 1 wherein the business opportunity is selected from the group consisting of financing, sales, service, leasing, renting, and purchasing and delivery terms.

3. The process of claim 1 wherein the business opportunity is selected from the group consisting of a competitor's: costs, business strategy, financial status, delivery dates, incentives, servicing terms.

4. The process of claim 1 wherein the step of implementing a business strategy comprises the steps of:
formulating and implementing a sales strategy based on a competitor's strategy.

5. The process of claim 4 wherein the step of implementing includes the steps of drafting a lease, rental or sale agreement taking specific advantage of the competitor's strategy.

6. The process of claim 1 wherein the step of implementing a business strategy comprises the steps of:
formulating and implementing a financing strategy.

7. A computer system programmed with software stored in a memory, wherein the software when activated implements the process steps of claim 1.

8. A computer system programmed with software stored in a memory, wherein the software when activated implements the process steps of claim 4.

9. A computer system programmed with software stored in a memory, wherein the software when activated implements the process steps of claim 6.
